(19) United States
(12) Patent Application Publication
(10) Pub. No.: US 2013/0039563 A1
(43) Pub. Date: Feb. 14, 2013

(54) METHOD OF GENERATING INSPECTION PROGRAM

(71) Applicants: Seung-Bum Han, Seoul (KR); Hee-Tae Kim, Yongin-si (KR)

(72) Inventors: Seung-Bum Han, Seoul (KR); Hee-Tae Kim, Yongin-si (KR)

(73) Assignee: KOH YOUNG TECHNOLOGY INC., Seoul (KR)

(21) Appl. No.: 13/576,829

(22) PCT Filed: Feb. 1, 2011
(86) PCT No.: PCT/KR2011/000683

§ 371 Date: Oct. 22, 2012

(30) Foreign Application Priority Data
Feb. 2, 2010 (KR) 10-2010-0009365

(51) Int. Cl. G06K 9/00

(52) U.S. Cl. 382/141

(57) ABSTRACT

A method of generating an inspection program that does not have a gerber file is shown. To generate the inspection program, a first image information is acquired by scanning a bare board, a second image information is acquired by scanning a solder-pasted board that solder is pasted on a pad area of the bare board, and by analyzing the first image information and the second image information an inspection program is generated. The first image information and the second image information may include at least one of a two-dimensional image information and a three-dimensional image information. The step for generating an inspection program calculates a difference between the first image information and the second image information, after extracting a position and a size of an area in which the difference occurs, then generates the inspection program by using the extracted information. Therefore, a bare board and a solder-pasted board may be each inspected and the accurate position and size of the solder pasted area may be extracted through analyzing the acquired two-dimensional image information or a three-dimensional image information differences.

### TECHNICAL FIELD

The present invention relates to a method of generating an inspection program, more particularly to a method of generating an inspection program by accurately extracting a solder paste area of the inspection board that does not have a gerber file.

### BACKGROUND ART

Generally, a mounted board that has electronic parts mounted on a printed circuit board is used in various electronic devices. The mounted board is produced by a method of solder pasting on a pad area of a bare board, thereafter combining electronic components to the solder paste area.

Meanwhile, before mounting electronic parts to the printed circuit board, a solder paste inspection (SPI) procedure that inspects a pad area of the printed circuit board if a solder is properly pasted, may be added. The SPI inspection is normally preceded by producing an inspection program from a gerber file that has inspection coordinates etc. of the pad area of the printed circuit board that is going to be inspected.

However, in some cases a printed circuit board that is going to be inspected may not have a gerber file. When the gerber file does not exist, a pad area that will be solder pasted is extracted by acquiring an image information through scanning a bare board that is not solder pasted and by using the extracted information an inspection program is produced. Though, it may be difficult to extract the pad area accurately because the information acquired by scanning a bare board may include a hole, a silk, etc. which looks similar to the pad.

### DETAILED DESCRIPTION OF THE INVENTION

### Objects of the Invention

Therefore, the present invention is to solve the problem, the object of the present invention is to provide a method of generating an inspection program by acquiring accurate position and size of a solder-pasted area of the inspection board that does not have a gerber file.

### Technical Solution

The first exemplary embodiment of a method of generating inspection program includes a step acquiring a first image information by scanning a bare board, a step of acquiring a second image information by scanning a solder-pasted board that solder is pasted on a pad area of the bare board and a step of generating an inspection program by analyzing the first image information and the second image information.

The first image information and the second image information include at least one of a two-dimensional image information and a three-dimensional image information.

The step for generating an inspection program may include a step of calculating a difference between the first image information and the second image information, a step of extracting a position and a size of an area in which the difference occurs, and a step of generating the inspection program by using the extracted information.

The step for calculating the difference between the first image information and the second image information, in one example, may calculate the difference between a two-dimensional image information included in the first image information and a three-dimensional image information included in the second image information. The difference between the two-dimensional image information may be a relative difference between gray scales.

The step for calculating the difference between the first image information and the second image information, in other example, may calculate the difference between a three-dimensional image information included in the first image information and a three-dimensional image information included in the second image information. The difference of the three-dimensional image information may be a difference of relative heights.

The step for calculating the difference between the first image information and the second image information, in another example, may calculate the difference between an image in which a height value of a three-dimensional image information included in the first image information is two-dimensionally imaged and an image in which a height value of a three-dimensional image information included in the second image information is two-dimensionally imaged.

Meanwhile, a plurality of first image informations is acquired from a plurality of bare boards, a plurality of second image informations is acquired from a plurality of solder-pasted board, and thereafter the inspection program may be generated by using a standard deviation or a mean value of the first image informations and a standard deviation or a mean value of the second image informations.

### Advantageous Effects

According to the method of generating inspection, a bare board and a solder-pasted board may be each inspected and the accurate position and size of the solder pasted area may be extracted through analyzing the acquired two-dimensional image information or a three-dimensional image information differences, this may create an accurate inspection program without a gerber file, and may increase productivity and shorten the creation time of the inspection program by reducing bad fault.

### BRIEF DESCRIPTION OF THE DRAWINGS

FIG. 1 is a flow chart illustrating a method of generating an inspection program according to the first embodiment of the present invention.

FIG. 2 is brief drawing illustrating an inspection apparatus according to the first embodiment of the present invention.

FIG. 3 is a plan drawing illustrating a bare board.

FIG. 4 is a plan drawing illustrating a solder-pasted board.

FIG. 5 is a flow chart illustrating step for generating an inspection program by using first image information and second image information.

FIG. 6 is a drawing illustrating a difference between a first image of a bare board and a second image of a solder-pasted board.

### EMBODIMENTS OF THE INVENTION

The invention is described more fully hereinafter with reference to the accompanying drawings, in which exemplary embodiments of the invention are shown.

However, this invention may be embodied in many different forms and should not be construed as limited to the embodiments set forth herein

Numerical terms such as “one”, “two”, etc. may be used as cardinal numbers to indicate various structural elements, however, the structural elements should not be limited by the terms. The terms are only used to distinguish one structural element from another structural element. For example, a first structural element may be named as second structural element if the right is not beyond the scope, the same applies to the second structural element that may be named as the first structural element.

The terms used in the present application are only to explain the specific embodiment and is not intended to limit the present invention. The terms “a”, “an” and “the” mean “one or more” unless expressly specified otherwise. The terms “including”, “comprising”, etc., are to designate features, numbers, processes, structural elements, parts, and combined component of the application, and should be understood that it does not exclude one or more different features, numbers, processes, structural elements, parts, combined component.

If not defined differently, all the terms used herein including technical or scientific terms, may be understood same as a person skilled in the art may understand.

Terms that are used herein are same as the terms defined in a commonly-used dictionary may be understood as same a contextual meaning, if not mentioned clearly, may not be understood as excessively or ideally.

The invention is described more fully hereinafter with reference to the accompanying drawings, in which exemplary embodiments of the invention are shown.

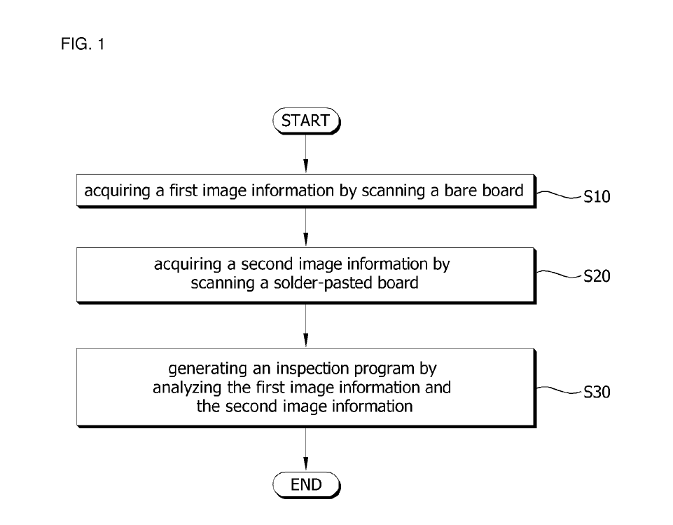

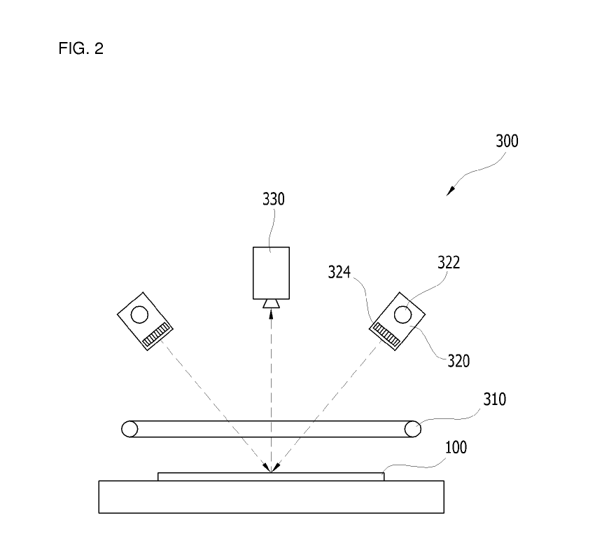

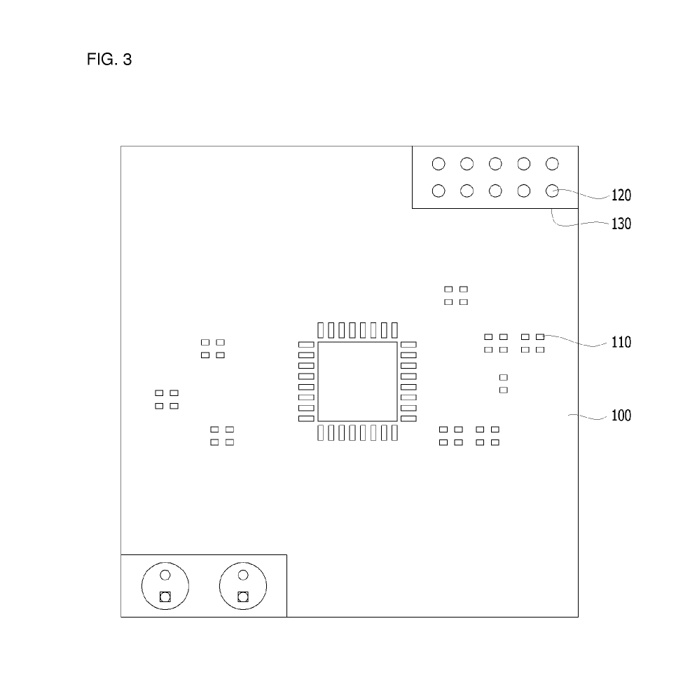

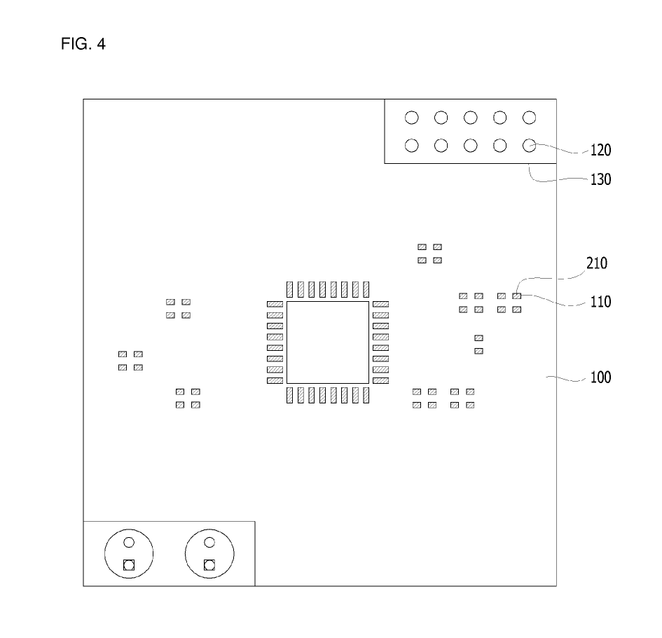

FIG. 1 is a flow chart illustrating a method of generating an inspection program according to the first embodiment of the present invention. FIG. 2 is brief drawing illustrating an inspection apparatus according to the first embodiment of the present invention. FIG. 3 is a plan drawing illustrating a bare board. FIG. 4 is a plan drawing illustrating a solder-pasted board.

Referring to FIGS. 1 to 3, to generate an inspection program of an inspection board that does not have a gerber file, a step S10 for acquiring a first image information by scanning a bare board, a step S20 for acquiring a second image information by scanning a solder-pasted board that solder is pasted on a pad area of the bare board and a step S30 for generating an inspection program by analyzing the first image information and the second image information are performed.

When a bare board 100 is mounted on an SPI (Solder Paste Inspection) inspection apparatus 300, the SPI inspection apparatus 300 may acquire the first image information that includes a two-dimensional image information and/or a three-dimensional image information of the bare board 100 through a camera 330 by using a two-dimensional light 310 and/or a three-dimensional light 320. The bare board 100 is a pre-solder paste board and indicates a board on which a pad area 100 that will be actually solder-pasted, and a hole 120, a silk 130, etc. that are not solder-pasted are formed as shown in FIG. 3. The two-dimensional light 310 is defined as a light to acquire a plan image that is a two-dimensional information image, to initial alignment or establish an area of an inspection. For example, the two-dimensional light 310 may be formed as a circular ring shape, and may include fluorescent lamp or light emitting diode, etc. Meanwhile, the two-dimensional light 310 may be disposed near to an inspection board. In addition, a light may further be disposed near to a camera 330. The three-dimensional light 320 is defined as a light to measure a three-dimensional shape of an inspection board by acquiring a three-dimensional image information such as a height information, visibility information, etc. For example, the three-dimensional light 320 may include a light source 322 and a lattice element 324 that transfers a light from the light source 322 into a phase transition light, and provides a light tilted to an inspection board in a predetermined angle. The lattice element 324 may be n number moved by 2 π/n by using a lattice movement element such as a piezo actuator (PZT) etc. to emit a phase transited three-dimensional light. The ‘n’ is two or more natural number. Meanwhile, the three-dimensional light 320 may be plural to be distanced in a predetermined angle around the camera 330 for increasing inspection accuracy. Meanwhile, the SPI inspection apparatus 300 shown in FIG. 2 is just an example, and various kinds of SPI inspection apparatus that includes a two-dimensional light and a three-dimensional light may be used.

Besides acquiring the first image information of the bare board 100, the SPI inspection apparatus 300 may acquire a second image information of the solder-pasted board 200. When the solder-pasted board 200 is mounted on the SPI inspection apparatus 300 instead of the bare board 100, the SPI inspection apparatus 300 may acquire the first image information that includes a two-dimensional image information and/or three-dimensional image information of the solder-pasted board 200 through a camera 330 by using a two-dimensional light 310 and/or three-dimensional light 320. The solder-pasted board 200 is a board that solder is pasted on a pad area of the bare board as shown in FIG. 4.

Hereafter, the SPI inspection apparatus 300 generates the inspection program by using the first image information that is acquired by scanning a bare board 100 and using the second image information that is acquired by scanning a solder-pasted board 200.

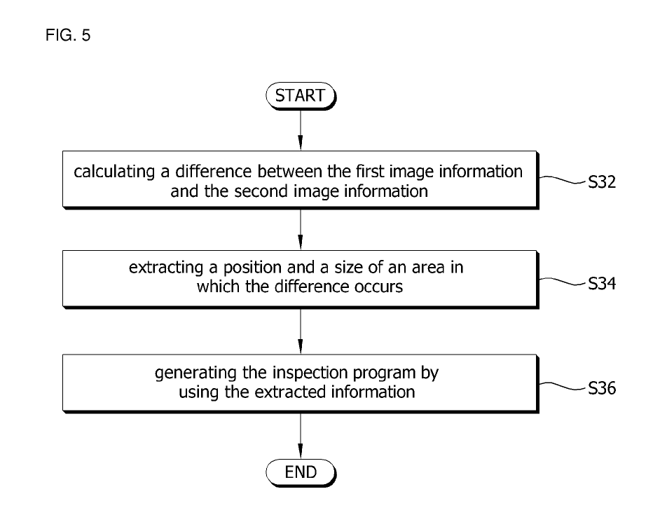

FIG. 5 is a flow chart illustrating step for generating an inspection program by using first image information and second image information.

Referring to FIG. 5, in step of S32, a SPI inspection apparatus 300 calculates a difference between the first image information and the second image information through a camera 330, in step of S34, after extracting a position and a size of an area in which the difference occurs, in step 36, then generates the inspection program by using the extracted information as step 36.

Various methods are used to calculate the difference between the first image information and the second image information. In one example, the difference between the bare board 100 and the solder-pasted board 200 may be calculated by comparing the two-dimensional image information of the bare board 100 included in the first image information and the two-dimensional image information of the solder-pasted board 200 included in the second image information. For example, the difference between the two-dimensional image informations may be gained by calculating relative difference between gray scales. In other example, the difference between the bare board 100 and the solder-pasted board 200 may be calculated by comparing the three-dimensional image information of the bare board 100 included in the first image information and the three-dimensional image information of the solder-pasted board 200 included in the second image information. For example, the difference between the three-dimensional image informations may be gained by calculating relative difference between heights. In another example, the difference between the bare board 100 and the solder-pasted board 200 may be calculated by comparing an image in which a height value of a three-dimensional image information of a bare board 100 included in the first image information is two-dimensionally imaged and an image in which a height value of a three-dimensional image information of a solder-pasted board 200 included in the second image information is two-dimensionally imaged.

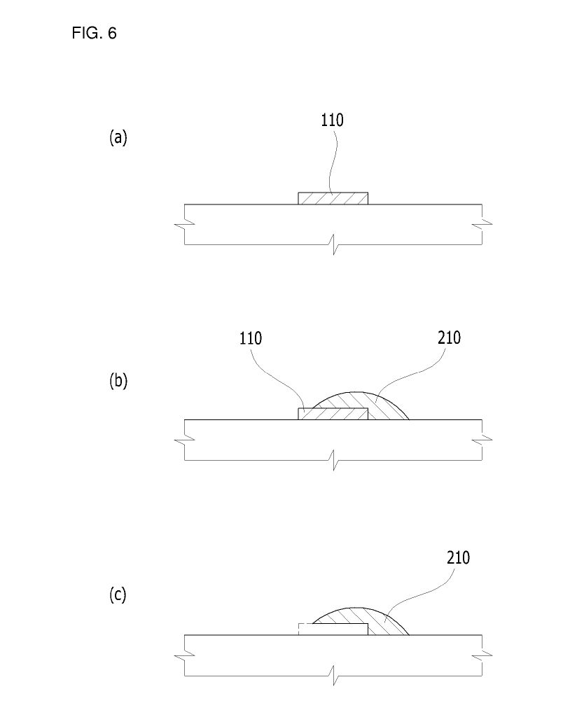

FIG. 6 is a drawing illustrating a difference between a first image of a bare board and a second image of a solder-pasted board.

Referring to FIG. 6, a first height information of the pad area 100 may be acquired by scanning the bare board 100 by using the SPI inspection apparatus 300 as shown in (a). In addition, a second height information of the solder 210 pasted region of the pad area 200 may be acquired by scanning the solder-pasted board 200 by using the SPI inspection apparatus 300 as shown in (b). Therefore, the practical position and size of the region that is solder pasted may be extracted as shown in (c) by subtracting the second height information of the solder-pasted board 200 from the first height information of the bare board 100.

Thereafter, the SPI inspection apparatus 300 may generate an inspection program that inspection area of the solder-pasted board 200 are set, by using the information such as the solder 210 pasted location and size. Meanwhile, the information of position and size of the solder pasted area that is extracted using the method above, may be sent to a mounting-part-apparatus for mounting parts, and may be used as a coordinates for mounting parts.

Meanwhile, extraction reliability about the solder-paste region may be verified by analyzing various data acquired by scanning multiple samples of bare boards 100 and solder-pasted boards 200. In other words, a plurality of first image informations is acquired from a plurality of bare boards 100, a plurality of second image informations is acquired from a plurality of solder-pasted board 200, and thereafter a reliability improved inspection program may be generated by comparing and analyzing a standard deviation or a mean value of the first image informations and a standard deviation or a mean value of the second image informations.

Therefore, a bare board 100 and a solder-pasted board 200 may be each inspected and the accurate position and size of the solder pasted area may be extracted through analyzing the acquired two-dimensional image information or a three-dimensional image information differences, this may create an accurate inspection program that does not have a gerber file, and may increase productivity and shorten the creation time of the inspection program by reducing bad fault.

The detailed description of the present invention is described with regard to the preferable embodiment of the present invention, however, a person skilled in the art may amend or modify the present invention within the spirit or scope in the following claim of the present invention. Therefore, the detailed description described above and the drawing illustrated hereinafter does not limit the technical idea of the invention.

What is claimed is:

1. A method of generating an inspection program, comprising:
acquiring a first image information by scanning a bare board;
acquiring a second image information by scanning a solder-pasted board that solder is pasted on a pad area of the bare board; and
generating an inspection program by analyzing the first image information and the second image information.

2. The method of claim 1, wherein each of the first image information and the second image information includes at least one of a two-dimensional image information and a three-dimensional image information.

3. The method of claim 2, wherein generating an inspection program comprises:
calculating a difference between the first image information and the second image information;
extracting a position and a size of an area in which the difference occurs; and
generating the inspection program by using the extracted information.

4. The method of claim 3, wherein calculating the difference between the first image information and the second image information, the difference between a two-dimensional image information included in the first image information and a two-dimensional image information included in the second image information are calculated.

5. The method of claim 4, wherein the difference between the two-dimensional image informations is a relative difference between gray scales.

6. The method of claim 3, wherein calculating the difference between the first image information and the second image information, the difference between a three-dimensional image information included in the first image information and a three-dimensional image information included in the second image information are calculated.

7. The method of claim 6, wherein the difference between the three-dimensional image informations is a relative difference between heights.

8. The method of claim 3, wherein calculating the difference between the first image information and the second image information,
the difference between an image in which a height value of a three-dimensional image information included in the first image information is two-dimensionally imaged and an image in which a height value of a three-dimensional image information included in the second image information is two-dimensionally imaged are calculated.

9. The method of claim 1,
wherein a plurality of first image informations is acquired from a plurality of bare boards,
a plurality of second image informations is acquired from a plurality of solder-pasted board, and
thereafter the inspection program is generated by using a standard deviation or a mean value of the first image informations and a standard deviation or a mean value of the second image informations.
